(19) United States
(12) Patent Application Publication
(10) Pub. No.: US 2002/0175182 A1
(43) Pub. Date: Nov. 28, 2002

(54) Self contained dispenser incorporating a user monitoring system

(76) Inventor: Shaun Kerry Matthews, Oswestry (GB)

Correspondence Address: DOWELL & DOWELL PC, SUITE 309, 1215 JEFFERSON DAVIS HIGHWAY, ARLINGTON, VA, 22202

(21) Appl. No.: 09/863,008

(22) Filed: May 23, 2001

(51) Int. Cl. B67D 5/08

(52) U.S. Cl. 222/52

(57) ABSTRACT

A user monitoring system is for use in association with dispensers, particularly soap dispensers, and it may be used to monitor the use of dispensers for a number of different purposes including proof of compliance, training, disciplinary action or evidence of good practice. The monitoring system includes a sensing system, a user identification system and data storage. The sensing system is for sensing a user. The user identification system is operably connected to and responsive to the sensing system for identifying a unique user whereby the user identification system is activated once the sensing system has sensed a user. The data storage is operably connected to the user identification system and is for recording the unique user. The user monitoring system may be connected to an automatic dispenser that dispenses liquid responsive to a signal from the sensing system.

### FIELD OF THE INVENTION

This invention relates to dispensers and in particular a self contained dispenser incorporating a user monitoring system.

### BACKGROUND OF THE INVENTION

Soap dispensers for liquid soap are well known and are widely used. They are used in commercial and industrial facilities as well as residences. More recently there has been a trend to automate fixtures in bathrooms, particularly in commercial and industrial facilities. Automation increases the likelihood that the fixtures will be used properly, reduces contamination and decreases the cleaning required. In addition, more recently there has been a trend to providing methods of monitoring use of the cleaning facilities and in particular methods of monitoring cleaning hands after use of the washroom facilities.

Many industries, notably healthcare, food preparation and food packaging, attempt to impose standards of personal hygiene and frequency of hand washing on their employees in order to protect the employees, their processes, their customers and the public at large. This has resulted in soap companies developing products aimed at providing the necessary levels of protection, the provision of ‘touch free’ automatic dispenser systems and training packages. However the efficacy of these systems relies on the integrity of the staff and their preparedness to use the cleansing products at the prescribed frequency.

Some attempts have been made to overcome this barrier. One example of such an attempt is the Simoniz Washclock™. This device includes a key pad operated time recorder which requires the user to type in a personal identification code each time they wash their hands. This is merely an electronic log and is open to abuse, neither ensuring that the hands are washed nor that the person typing the code is actually the claimed person.

Another product is the Clean Hands™ system of the Clean Hands Company. This product requires a highly complex system of tags, imaging systems and computers that automates the process of recording who washes, when and validates the integrity of the washing process by checking for residual traces of a dye incorporated in the soap formulation. The system is potentially highly effective but has very high installation costs, limiting its application. This system uses long range active radio frequency tags and one problem with the use of long range tags is that if more than one person is in the vicinity the system is unable to discriminate who is doing what. Further this system requires a number of components that must function in concert so that the system can check the integrity of hand washing by users. Because of its complexity and consequent cost, very few industries would be able to justify the cost of installation and monitoring.

Accordingly, it would be advantageous to provide an automatic soap dispenser that is easy to use and relatively low cost. Further it would be advantageous to provide an automatic soap dispenser that records a user identification when the user's hands are under the soap dispenser.

### SUMMARY OF THE INVENTION

The object of the present invention is to address the shortcomings of both the above mentioned prior art systems by providing a system that senses when the user's hands are under the dispensing nozzle of the dispenser, interrogating a passive RF tag worn by the user and dispensing soap. Alternatively, the system may be adapted to interrogate the individual user, thereby accurately identifying the user by way of thumb print, eye scan, voice recognition or the like.

The present invention is a user monitoring system for use in association with dispensers. The monitoring system includes a sensing system, a user identification system and data storage. The sensing system is for sensing a user. The user identification system is operably connected to and responsive to the sensing system for identifying a unique user whereby the user identification system is activated once the sensing system has sensed a user. The data storage is operably connected to the user identification system and is for recording the unique user.

In another aspect of the invention a self contained dispenser incorporating a user monitoring system includes a liquid dispenser, a sensing system, a user identification system, data storage and a power supply. The liquid dispenser includes a method for dispensing liquid. The sensing system is for sensing the user. The user identification system is operably connected to and responsive to the sensing system for identifying a unique user. The user identification system is activated once the sensing system has sensed a user. The data storage is operably connected to the user identification system for recording the unique user. The power supply is operably connected to the sensing system, the user identification system and the data storage system. The liquid dispensing method may be an automatic dispenser that is responsive to a signal from the sensing system.

A further aspect of the invention includes a method of monitoring the use of a dispenser. The method includes the steps of sensing the presence of an object; emitting an interrogation signal; receiving a tag signal; storing the data and downloading the data. The tag signal is responsive to the interrogation signal and the tag signal includes a unique identifier. The data that is stored includes the unique identifier.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a soap dispenser incorporating the user monitoring system of the present invention;

FIG. 2 is a blown apart perspective view of an automatic soap dispenser incorporating the user monitoring system of the present invention;

FIG. 3 is a flow chart showing the steps of the user monitoring system; and

FIG. 4 is a flow chart showing the steps of download the information from the user monitoring system.

### DETAILED DESCRIPTION OF THE INVENTION

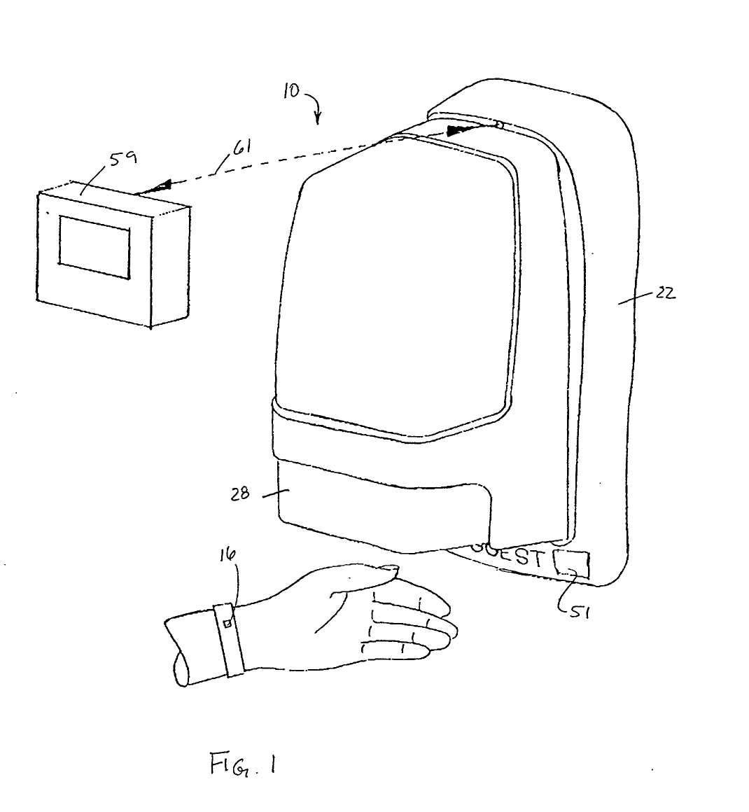

Referring to FIG. 1, a self contained dispenser incorporating a user monitoring system is shown generally at 10. It will be appreciated by those skilled in the art that the dispenser shown herein is by way of example only and that the monitoring system may be used in connection with any soap dispenser. Further it will be appreciated by those skilled in the art that although the description herein is discussed in regard to soap dispensers the same system may be used with regard to any liquid or foam where it is advantageous to monitor the use. For example it may be used with sun screen, protective creams, medicated creams or antibacterial waterless cleansers and the like.

The dispenser 10 includes a user monitoring system 12 and a dispensing system 14. The user monitoring system 12 includes a sensing system and a recording system. In addition the dispenser includes those features that are normally present with dispensers such as a cover 18, a bottle holder 20, a bottle (not shown) and a base 22.

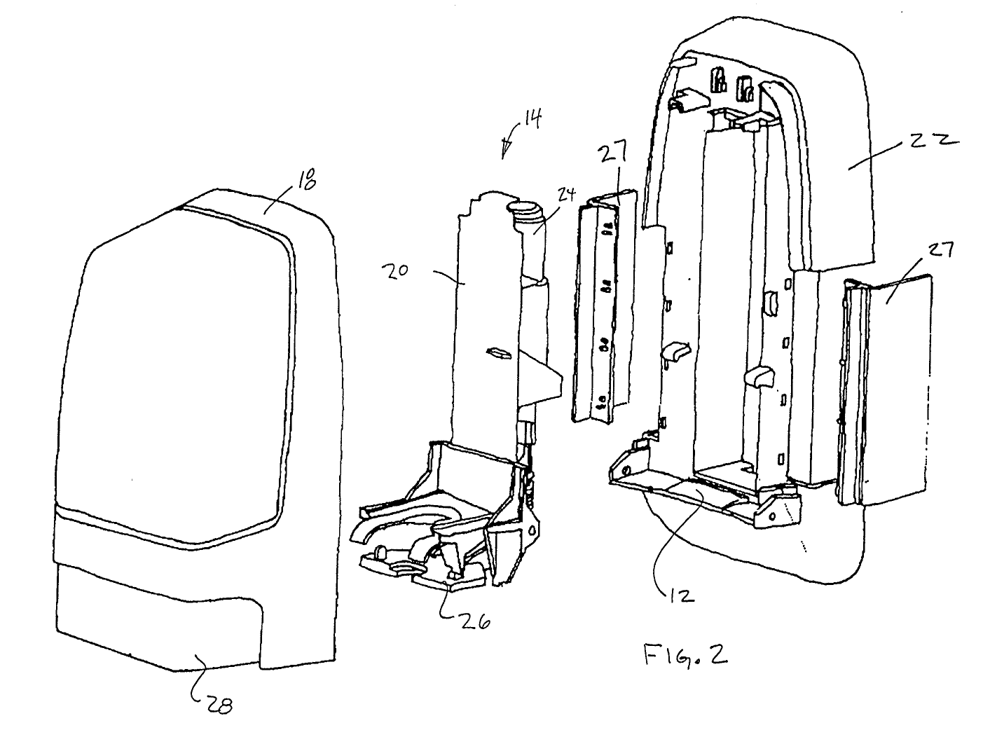

Referring to FIG. 2, the dispenser system 14 shown herein is an automatic dispenser system. The automatic dispensing system 14 includes a motor 24 which is operably connected to a moving plate 26 which when activated causes the plate to move thereby triggering the dispensing of the liquid (not shown). The automatic system is operably connected to a power source. The dispenser shown herein uses ‘D’ cell batteries (not shown), three on each side which are covered by removable battery covers 27. Alternatively automatic system is connected to an adaptor which is plugged into an outlet or the automatic system is connected to a plug which is plugged in to an outlet. It will be appreciated by those skilled in the art that there are a wide variety of dispensers and the system described herein can be adapted for use with such other dispensers.

Alternatively the dispenser system 14 may be a manual dispenser system wherein a movable lever 28 is hingeably attached to cover 18. Lever 28 engages movable plate 26 such that moving the lever 28 causes the moving plate 26 to move thereby triggering the dispensing of the liquid.

Monitoring system 12 includes a sensing system, a user identification system and data storage. The sensing system may be a motion sensor or a proximity sensor. In the embodiment shown herein the sensor system chosen is a proximity sensor that monitors the change in capacitive flux within a predetermined range. Preferably the QProx™ made by the Quantum Research Group and described in detail in U.S. Pat. Nos. 5,730,165 issued Mar. 24, 1998 and 5,682,032 issued Oct. 28, 1997 both issued to Philipp may be adapted for use in the system described herein. The sensing system includes a ground plane operably connected to the QProx™. The ground plane may be a conductive surface, such as self adhesive aluminium foil, on the inside of the bottom of the dispenser 10. The capacitive flux sensor has a number of advantages over an infrared sensor which is commonly used with touch free dispensers. Infrared sensors have many problems with regard to battery life, changes in ambient light levels and they can be unresponsive to certain skin colours. Further, they are easily disabled by dirt and vandalism and they will respond to anything reflective therefore a user could operate these dispensers easily with a newspaper or other object. The capacitive flux sensor overcomes many of these problems. Further the motion sensor may work in conjunction with the dispensing system and the monitoring system.

The user identification system may include a radio frequency (RF) tag 16 (shown in FIG. 1). Preferably the RF tag 16 is a short range passive RF tags such as those commonly used for identifying pets, livestock, bicycles and the like. Preferably the range of the RF tag 16 is no greater than 100 mm or 4 inches. Each tag 16 has an unique user identification code. The RF tag may be in an identification wrist band or an identification swipe card. One advantage of using a short range tag is that it reduces the chances of incorrectly identifying a user. With the longer range tags there is a chance that if more than one user is in the washroom the monitoring system may not be able to differentiate between the users within range.

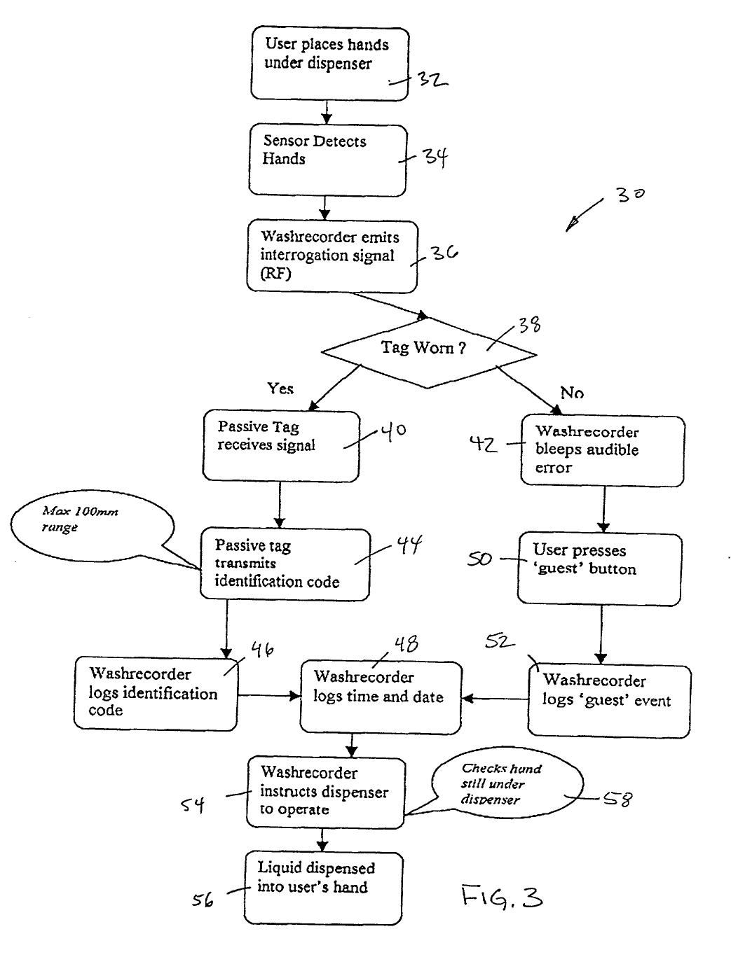

Referring to FIG. 3 the user monitoring system is shown generally at 30. Firstly the user places 32 a hand under the dispenser 10. The sensor detects 34 the presence of a hand and the recording device emits 36 an interrogation signal. The interrogation signal responds 38 to the presence of a tag 16 (shown in FIG. 1). If a tag is present the system receives 40 a signal from the tag 16. If no tag is present the system does not receive a signal and the system emits 42 an audible error signal. The tag 16 transmits 44 the user identification code. The monitoring system logs 46 the user identification code and it logs 48 the time and the date.

If there is no tag 16 present an error signal is emitted 42 and the user must press 50 a guest or override button 51. The monitoring system logs 52 the “guest” and it logs 48 the date and time of the guest.

The monitoring system instructs 54 the dispenser system to dispense liquid and then liquid is dispensed 56. Prior to dispensing the liquid the dispenser system may check 58 that the hand is still within a predetermined range. It will be appreciated that this step may be redundant where the speed of the monitoring system is virtually instantaneous. However, particularly when the “guest” button must be pressed or where alternate identification system is used it may be important to check that a hand is within range.

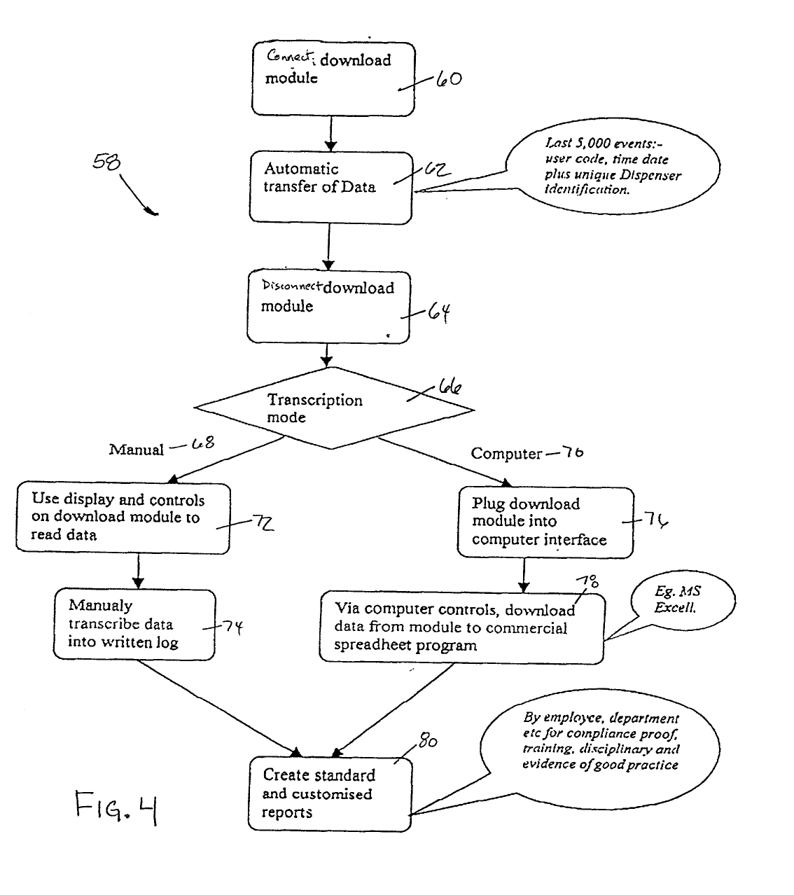

Referring to FIG. 4, from time to time the system user will download the information logged into the monitoring system. The steps used to download the information are shown generally at 58. Firstly the user operably connects 60 the download module 59 (shown in FIG. 1). The module could be connected by may of a male/female hard wire connection, an infrared connection 61, a short range radio connection or the like. Once the connection has been made the data is transferred 62 to the download module. Preferably this data is transferred automatically once download module is connected. Thereafter the download module is disconnected 64. Once the download module has been retrieved the data is transcribed 66 which may be done manually 68 via a display unit enabling manual transcription or by way of computer 70 such as a portable computing device. Typically the data that is retrieved is the last 5,000 events. However, this may be determined by the system user and will depend on the capacity of the chip that is used.

In the manual stream the user reads 72 the data on the download module using the display and controls and manually transcribes 74 it. In the computer stream the download module is operably connected 76 to a computer interface and the data is imported 78 into a program. Preferably it is imported into a spreadsheet program such as Microsoft Exel™. The data is then used to create 80 reports. These reports may be standardized reports or customized reports. The reports may be arranged by employee or department or the like. These reports may be used for such things as proof of compliance, training, disciplinary action or evidence of good practice.

The self contained dispenser incorporating a user monitoring system described herein is easy to use, easy to instal and easy to maintain. Although it may be possible for employees or users to circumvent the system (eg., by giving their tag to another employee or not washing the soap off after the event) it is easier to comply. The information generated can be used for training purposes, disciplinary action against wayward employees, providing a permanent record to satisfy health officials. It can also be used to change the washing habits of employees ensuring higher standards of sanitation. It can also be used for such liquids as sun screen or other protective or medicated creams to help a employer monitor their use and help to regulate the use thereof by employees. Each dispenser will have a unique identification code so that which dispenser used by the users is also discernible from the data.

There are a number of ways that the self contained dispenser incorporating a user monitoring system of the present invention may be modified. For example the user identifying system may be a voice recognition, thumb print or retina scanner. It could also be modified where appropriate to use an infrared active tag. These alternatives will become more feasible as the cost of these devices is reduced. It will be appreciated by those skilled in the art that the user monitoring system could easily be modified to incorporate different user identification systems. Further the monitoring system could be expanded to monitor those employees entering the washing room and confirming that before leaving the employee uses the dispenser. It could also be used to operate, in addition to the soap dispenser, an automatic faucet and thereby controlling the water use. The system could be arranged such that the water is only turned on after soap has been dispensed. The system could also be adapted to use some of the wireless technology (eg. Bluetooth ™) as they become more common and more affordable.

It will be appreciated that the above description related to one embodiment by way of example only. Many variations on the invention will be obvious to those skilled in the art and such obvious variations are within the scope of the invention as described herein whether or not expressly described.

What is claimed as the invention is:

1. A monitoring system for use in association with dispensers for monitoring their use comprising:
a sensing system for sensing a user;
a user identification system operably connected to and responsive to the sensing system for identifying a unique user whereby the user identification system is activated once the sensing system has sensed a user; and
a data storage means operably connected to the user identification system for recording the unique user.

2. A user monitoring system as claimed in claim 1 wherein the sensing system includes a proximity sensor.

3. A user monitoring system as claimed in claim 1 wherein the sensing system is responsive to a change in capacitive flux.

4. A user monitoring system as claimed in claim 2 wherein the user identification system includes a passive radio frequency tag that has a unique identifier that corresponds to the unique user and the tag is responsive to a signal generated by the sensing system.

5. A user monitoring system as claimed in claim 4 wherein the tag is operable in a range of not more than 100 mm.

6. A user monitoring system as claimed in claim 5 wherein the data storage system further records the date and the time of the user identification.

7. A user monitoring system as claimed in claim 6 further including a download module operably connectable to the data storage system for downloading the data recorded in the data storage system.

8. A user monitoring system as claimed in claim 7 wherein the sensing system is operably connected to an automatic dispensing system that dispenses liquid responsive to a dispensing signal from the sensing system.

9. A user monitoring system as claimed in claim 2 wherein the user identification system includes voice recognition identification that identifies the unique user.

10. A user monitoring system as claimed in claim 2 wherein the user identification system includes iris scanning recognition that identifies the unique user.

11. A user monitoring system as claimed in claim 2 wherein the user identification system includes thumb print recognition that identifies the unique user.

12. A self contained dispenser incorporating a user monitoring system comprising
a liquid dispenser including a means for dispensing liquid;
a sensing system for sensing the user;
a user identification system operably connected to and responsive to the sensing system for identifying a unique user whereby the user identification system is activated once the sensing system has sensed a user;
a data storage means operably connected to the user identification system for recording the unique user; and
a power supply operably connected to the sensing system, the user identification system and the data storage system.

13. A self contained dispenser as claimed in claim 12 wherein the sensing system includes a proximity sensor.

14. A self contained dispenser as claimed in claim 13 wherein the sensing system is responsive to a change in capacitive flux.

15. A self contained dispenser as claimed in claim 13 wherein the user identification system includes a passive radio frequency tag that has a unique identifier that corresponds to a unique user and the tag is responsive to a signal generated by the sensing system.

16. A self contained dispenser as claimed in claim 15 wherein the tag is operable in a range of not more than 100 mm.

17. A self contained dispenser as claimed in claim 16 wherein the data storage system further records the date and the time of the user identification.

18. A self contained dispenser as claimed in claim 17 further including a download module operably connectable to the data storage system for downloading the data recorded in the data storage system.

19. A self contained dispenser as claimed in claim 18 further including an override button.

20. A self contained dispenser as claimed in claim 19 wherein the means for dispensing liquid is an automatic dispenser which is operably connected to the sensing means and the automatic dispenser is responsive to a dispense signal from the sensing means.

21. A self contained dispenser as claimed in claim 20 wherein the sensing means sends the dispense signal after the unique identifier is recorded.

22. A self contained dispenser as claimed in claim 21 wherein the power supply includes batteries housed inside the dispenser.

23. A self contained dispenser as claimed in claim 21 wherein the power supply includes an adapter that is connectable to an external plug.

24. A method of monitoring the use of a dispenser including the steps of:
sensing the presence of an object;
emitting an interrogation signal;
receiving a tag signal responsive to the interrogation signal wherein the tag signal includes a unique identifier;
storing data including the unique identifier; and
downloading the data.

25. A method of monitoring use as claimed in claim 24 wherein the data further includes the date and time of receiving the unique identifier.

26. A method of monitoring use as claimed in claim 25 further including the step of instructing the dispenser to dispense liquid.

27. A method of monitoring use as claimed in claim 26 further including the step of not receiving a tag signal, emitting an error signal and receiving an override signal and wherein the data includes an override event.
